(19) United States
(12) Patent Application Publication
(10) Pub. No.: US 2021/0049523 A1
(43) Pub. Date: Feb. 18, 2021

(54) SYSTEMS AND METHODS FOR PREDICTING DESTINATION IN ONLINE TO OFFLINE SERVICE

(71) Applicant: BEIJING DIDI INFINITY TECHNOLOGY AND DEVELOPMENT CO., LTD., Beijing (CN)

(72) Inventors: Ran CHEN, Beijing (CN); Huan CHEN, Beijing (CN); Qi SONG, Beijing (CN)

(73) Assignee: BEIJING DIDI INFINITY TECHNOLOGY AND DEVELOPMENT CO., LTD., Beijing (CN)

(21) Appl. No.: 17/088,639

(22) Filed: Nov. 4, 2020

Related U.S. Application Data
(63) Continuation of application No. PCT/CN2018/093215, filed on Jun. 28, 2018.

(51) Int. Cl. G06Q 10/04; G06Q 10/06

(52) U.S. Cl. CPC G06Q 10/047; G06Q 10/06311

(57) ABSTRACT

A method may include determining that a service requester intends to request a service from a first location at a first time point. The method may include obtaining historical orders requested by the service requester in a first time period prior to the first time point. The method may include determining one or more candidate destinations based on the historical orders. The method may include, for each of the one or more candidate destinations, selecting at least one historical order based on the first time point. The method may include determining a probability associated with the each of the one or more candidate destinations based on a number of the selected at least one historical order and a number of historical orders associated with the each of the one or more candidate destinations. The method may include determining a destination based on the one or more probabilities.

### CROSS-REFERENCE TO RELATED APPLICATIONS

This application is a Continuation of International Application No. PCT/CN2018/093215, filed on Jun. 28, 2018, the contents of which are hereby incorporated by reference in its entirety.

### TECHNICAL FIELD

The present disclosure generally relates to systems and methods for predicting a destination in an online to offline service, and more specifically, relates to systems and methods for predicting a destination in an online to offline service using non-parametric statistics.

### BACKGROUND

A taxi-hailing application implemented on the user terminal, i.e., a smart phone, communicates via a network with an online to offline service platform implemented on a server terminal periodically for service and/or location information. When it is determined from these communications that a passenger intends to call for a taxi (e.g., opening the taxi-hailing application installed in the passenger's smart phone), the online to offline service platform may transmit a recommended destination to be displayed on the passenger's smart phone. If the recommended destination matches the passenger's intent destination, the passenger may quickly input the destination by selecting the recommended destination. In existing technology, statistic methods such as normal distribution and Beta distribution may be used to determine a recommended destination. However, the recommended destination using the statistic methods often does not match the passenger's intent. Therefore, it is desirable to provide systems and methods for predicting a destination in an online to offline service to improve the accuracy of recommending a destination to a passenger.

### SUMMARY

According to a first aspect of the present disclosure, a system for predicting a destination in an online to offline service system may include one or more storage media and one or more processors configured to communicate with the one or more storage media. The one or more storage media may include a set of instructions. When the one or more processors executing the set of instructions, the one or more processors may be directed to perform one or more of the following operations. The one or more processors may determine that a service requester intends to request a service from a first location at a first time point. The one or more processors may obtain a plurality of historical orders requested by the service requester in a first time period prior to the first time point in response to the determination. The one or more processors may determine one or more candidate destinations based on the plurality of historical orders. For each of the one or more candidate destinations, the one or more processors may select, from the plurality of historical orders, at least one historical order associated with the each of the one or more candidate destinations based on the first time point. For each of the one or more candidate destinations, the one or more processors may determine a probability associated with the each of the one or more candidate destinations based on a number of the selected at least one historical order and a number of historical orders associated with the each of the one or more candidate destinations, wherein the probability indicates a likelihood that the service requester intends to travel to the each of the one or more candidate destinations at the first time point. The one or more processors may determine, from the one or more candidate destinations, a destination to be recommended to the service requester based on the one or more probabilities associated with the one or more candidate destinations, respectively.

In some embodiments, the one or more processors may transmit the destination to a requester terminal associated with the service requester causing the destination displayed on a user interface of the requestor terminal.

In some embodiments, a destination of the selected at least one historical order may match the each of the one or more candidate destinations, and a departure time associated with the selected at least one historical order may be within a second time period that includes the first time point.

In some embodiments, a departure location associated with the selected at least one historical order may be within a distance range including the first location.

In some embodiments, to determine the number of the selected at least one historical order, the one or more processors may determine a weight for each of the selected at least one historical order based on an interval between a departure time associated with the each of the selected at least one historical order and the first time point. The one or more processors may determine the number of the selected at least one historical order based on a sum of the weights associated with the selected at least one historical order, respectively.

In some embodiments, to determine the weight for each of the selected at least one historical order, the one or more processors may determine a half-life based on the plurality of historical orders. The one or more processors may determine the weight for the each of the selected at least one historical order based on the half-life and the interval between the departure time associated with each of the selected at least one historical order and the first time point.

In some embodiments, to determine, from the one or more candidate destinations, the destination to be recommended to the service requester based on the one or more probabilities associated with the one or more candidate destinations, respectively, the one or more processors may select a candidate destination with a maximum probability from the one or more candidate destinations. The one or more processors may determine whether the maximum probability exceeds a probability threshold. The one or more processors may determine the candidate destination with the maximum probability as the destination to be recommended to the service requester in response to a determination that the maximum probability exceeds a probability threshold.

According to another aspect of the present disclosure, a method for predicting a destination in an online to offline service system may include one or more of the following operations. One or more processors may determine that a service requester intends to request a service from a first location at a first time point. The one or more processors may obtain a plurality of historical orders requested by the service requester in a first time period prior to the first time point in response to the determination. The one or more processors may determine one or more candidate destinations based on the plurality of historical orders. For each of the one or more candidate destinations, the one or more processors may select, from the plurality of historical orders, at least one historical order associated with the each of the one or more candidate destinations based on the first time point. For each of the one or more candidate destinations, the one or more processors may determine a probability associated with the each of the one or more candidate destinations based on a number of the selected at least one historical order and a number of historical orders associated with the each of the one or more candidate destinations, wherein the probability indicates a likelihood that the service requester intends to travel to the each of the one or more candidate destinations at the first time point. The one or more processors may determine, from the one or more candidate destinations, a destination to be recommended to the service requester based on the one or more probabilities associated with the one or more candidate destinations, respectively.

According to yet another aspect of the present disclosure, a system for predicting a destination in an online to offline service system may include an order obtaining module configured to determine that a service requester intends to request a service from a first location at a first time point, and obtain a plurality of historical orders requested by the service requester in a first time period prior to the first time point in response to the determination. The system may also include a candidate destination determination module configured to determine one or more candidate destinations based on the plurality of historical orders. The system may also include a probability determination module configured to select, for each of the one or more candidate destinations, at least one historical order associated with the each of the one or more candidate destinations based on the first time point from the plurality of historical orders, determine a probability associated with the each of the one or more candidate destinations based on a number of the selected at least one historical order and a number of historical orders associated with the each of the one or more candidate destinations. The probability may indicate a likelihood that the service requester intends to travel to the each of the one or more candidate destinations at the first time point. The system may also include a destination determination module configured to determine, from the one or more candidate destinations, a destination to be recommended to the service requester based on the one or more probabilities associated with the one or more candidate destinations, respectively.

According to yet another aspect of the present disclosure, a non-transitory computer readable medium may comprise at least one set of instructions for predicting a destination in an online to offline service system. The at least one set of instructions may be executed by one or more processors of a computer server. The one or more processors may determine that a service requester intends to request a service from a first location at a first time point. The one or more processors may obtain a plurality of historical orders requested by the service requester in a first time period prior to the first time point in response to the determination. The one or more processors may determine one or more candidate destinations based on the plurality of historical orders. For each of the one or more candidate destinations, the one or more processors may select, from the plurality of historical orders, at least one historical order associated with the each of the one or more candidate destinations based on the first time point. For each of the one or more candidate destinations, the one or more processors may determine a probability associated with the each of the one or more candidate destinations based on a number of the selected at least one historical order and a number of historical orders associated with the each of the one or more candidate destinations, wherein the probability indicates a likelihood that the service requester intends to travel to the each of the one or more candidate destinations at the first time point. The one or more processors may determine, from the one or more candidate destinations, a destination to be recommended to the service requester based on the one or more probabilities associated with the one or more candidate destinations, respectively.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online to offline service system according to some embodiments of the present disclosure;

FIG. 2 is a schematic diagram illustrating exemplary hardware and/or software components of a computing device on which a processing engine may be implemented according to some embodiments of the present disclosure;

FIG. 3 is a schematic diagram illustrating exemplary hardware and/or software components of a mobile device on which one or more terminals may be implemented according to some embodiments of the present disclosure;

FIG. 4 is a schematic block diagram illustrating an exemplary processing engine according to some embodiments of the present disclosure;

FIG. 5 is a flowchart illustrating an exemplary process for determining a destination for a service requester who intends to request a transportation service according to some embodiments of the present disclosure; and

FIG. 6 is a schematic diagram illustrating an exemplary process for determining a first number of selected at least one historical order according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods in the present disclosure are described primarily regarding recommending a destination to a passenger intending to ask for a taxi in a taxi-hailing service, it should also be understood that this is only one exemplary embodiment. The systems and methods in the present disclosure may be applied to any application scenario in which a user requires to search a location. In some embodiments, the systems and methods of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The systems and methods of the present disclosure may be applied to taxi hailing, chauffeur services, delivery service, carpool, bus service, take-out service, driver hiring, vehicle hiring, bicycle sharing service, train service, subway service, shuttle services, location service, map service, or the like. For example, the systems and methods in the present disclosure may be applied to a scenario, in which a user intends to search a location to head for in a navigation service. As another example, the systems and methods in the present disclosure may be applied to a scenario, in which a user intends to search a location for letter or package delivery in a delivery service. As still another example, the systems and methods in the present disclosure may be applied to a scenario, in which a user intends to search a location for take-out food delivery in a take-out service.

In some embodiments, when it is determined that a passenger intends to call for a taxi (e.g., using a taxi-hailing application installed in the passenger's smart phone), an online to offline service platform communicating with the taxi-hailing application may transmit a recommended destination to be displayed on the passenger's smart phone. The recommended destination may match the passenger's intent destination such that a quick input of the location to taxi-hailing application is achieved. To this end, the systems and method in the present disclosure may determine a plurality of candidate destinations based on historical orders requested by the passenger in the past. For each of the plurality of candidate destinations, the systems and method in the present disclosure may determine a probability indicating a likelihood that the passenger intends to travel to each of the plurality of candidate destinations using non-parametric statistics. In the non-parametric statistics, the departure times, the departure locations, and the destinations of the historical orders may be considered. The systems and method in the present disclosure may recommend the candidate destination with a maximum probability among the plurality of candidate destinations to the passenger.

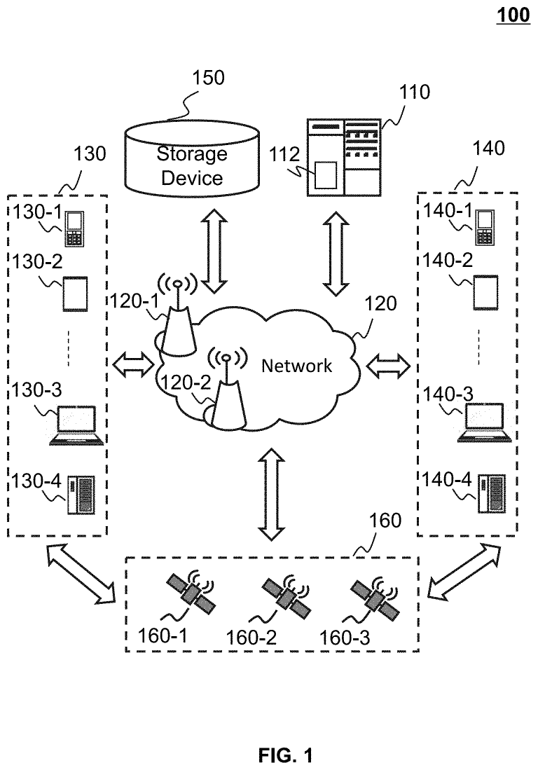

FIG. 1 is a schematic diagram of an exemplary online to offline service system 100 according to some embodiments of the present disclosure. The online to offline service system 100 may include a server 110, a network 120, a requester terminal 130, a provider terminals 140, a storage device 150, and a positioning system 160.

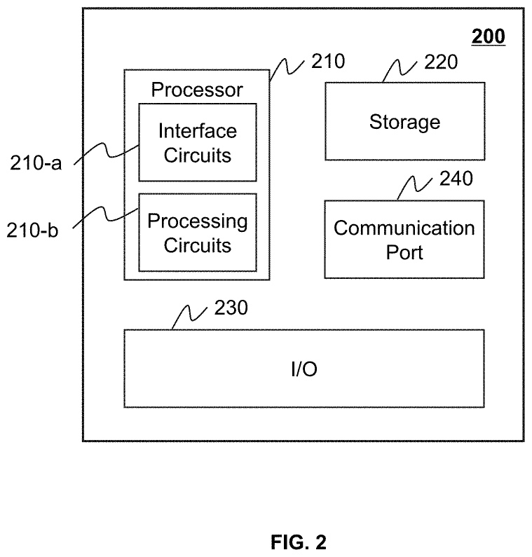

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in a user terminal (e.g., the requester terminal 130, or the provider terminals 140), and/or the storage device 150 via the network 120. As another example, the server 110 may be directly connected to the user terminal (e.g., the requester terminal 130, or the provider terminals 140), and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may predict a destination and recommend the destination to a service requester. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the online to offline service system 100 (e.g., the server 110, the requester terminal 130, the provider terminals 140, the storage device 150, and the positioning system 160) may send information and/or data to other component(s) in the online to offline service system 100 via the network 120. For example, the processing engine 112 may obtain historical orders requested by a service requester from the storage device 150 and/or the requester terminal 130 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the online to offline service system 100 may be connected to the network 120 to exchange data and/or information.

In some embodiments, a service requester may be a user of the requester terminal 130. In some embodiments, the user of the requester terminal 130 may be someone other than the service requester. For example, a user A of the requester terminal 130 may use the requester terminal 130 to send a service request for a user B, or receive service and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a user D, and/or information or instructions from the server 110. In some embodiments, “service requester,” “requester,” and “requester terminal” may be used interchangeably, and “service provider,” “provider,” and “provider terminal” may be used interchangeably.

In some embodiments, the requester terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, a RiftCon™, a Fragments™, a Gear VR™, etc. In some embodiments, the built-in device in the motor vehicle 130-4 may include an onboard computer, an onboard television, etc. In some embodiments, the requester terminal 130 may be a device with positioning technology for locating the position of the service requester and/or the requester terminal 130.

In some embodiments, the provider terminal 140 may be similar to, or the same device as the requester terminal 130. In some embodiments, the provider terminal 140 may be a device with positioning technology for locating the position of the driver and/or the provider terminal 140. In some embodiments, the requester terminal 130 and/or the provider terminal 140 may communicate with other positioning device (e.g., a positioning system 160) to determine the position of the service requester, the requester terminal 130, the driver, and/or the provider terminal 140. In some embodiments, the requester terminal 130 and/or the provider terminal 140 may send positioning information to the server 110.

The storage device 150 may store data and/or instructions. In some embodiments, the storage device 150 may store data obtained from the user terminal (e.g., the requester terminal 130, or the provider terminals 140) and/or the server 110. For example, the storage device 150 may store a plurality of historical orders requested by a service requester obtained from the user terminal (e.g., the requester terminal 130, or the provider terminals 140). In some embodiments, the storage device 150 may store data and/or instructions that the server 110 may execute or use to perform exemplary methods described in the present disclosure. For example, the storage device 150 may store instructions that the processing engine 112 may execute to predict a destination and recommend the destination to a service requester. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the online to offline service system 100 (e.g., the server 110, the requester terminal 130, the provider terminals 140, the positioning system 160). One or more components in the online to offline service system 100 may access the data or instructions stored in the storage device 150 via the network 120. In some embodiments, the storage device 150 may be directly connected to or communicate with one or more components in the online to offline service system 100 (e.g., the server 110, the requester terminal 130, the provider terminal 140, the positioning system 160). In some embodiments, the storage device 150 may be part of the server 110.

The positioning system 160 may determine information associated with an object, for example, the requester terminal 130. For example, the positioning system 160 may determine a location of the user terminal (e.g., the requester terminal 130, or the provider terminals 140) in real time. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, an accumulative mileage number, or a current time. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, or the user terminal (e.g., the requester terminal 130, or the provider terminals 140) via wireless connections.

FIG. 2 is a schematic diagram illustrating exemplary hardware and/or software components of a computing device on which the processing engine 112 may be implemented according to some embodiments of the present disclosure. As illustrated in FIG. 2, the computing device 200 may include a processor 210, a storage 220, an input/output (I/O) 230, and a communication port 240.

The processor 210 (e.g., logic circuits) may execute computer instructions (e.g., program code) and perform functions of the processing engine 112 in accordance with techniques described herein. For example, the processor 210 may include interface circuits 210-a and processing circuits 210-b therein. The interface circuits may be configured to receive electronic signals from a bus (not shown in FIG. 2), wherein the electronic signals encode/include structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus.

The computer instructions may include, for example, routines, programs, objects, components, data structures, procedures, modules, and functions, which perform particular functions described herein. For example, the processor 210 may predict a destination and recommend the destination to a service requester. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the user terminal (e.g., the requester terminal 130, or the provider terminals 140), the storage device 150, and/or any other component of the online to offline service system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the processing engine 112 for predicting a destination and recommending the destination to a service requester.

The I/O 230 may input and/or output signals, data, information, etc. In some embodiments, the I/O 230 may enable a user interaction with the processing engine 112. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing engine 112 and the user terminal (e.g., the requester terminal 130, or the provider terminals 140), the positioning system 160, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc.

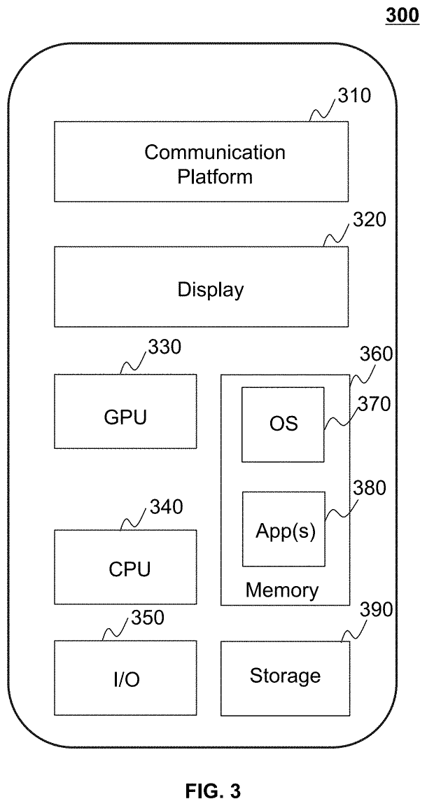

FIG. 3 is a schematic diagram illustrating exemplary hardware and/or software components of a mobile device on which the user terminal (e.g., the requester terminal 130, or the provider terminals 140) may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 (e.g., a taxi-hailing application) may include a browser or any other suitable mobile apps for receiving and rendering information relating to transportation services or other information from the processing engine 112. User interactions with the information stream may be achieved via the I/O 350 and provided to the processing engine 112 and/or other components of the online to offline service system 100 via the network 120. Merely by way of example, a destination recommended to a service requester may be displayed in the requester terminal 130 through the display 320. As another example, a service requester may input a departure location and/or a destination through the I/O 350.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

One of ordinary skill in the art would understand that when an element of the online to offline service system 100 performs, the element may perform through electrical signals and/or electromagnetic signals. For example, when the processing engine 112 processes a task, such as making a determination, or identifying information, the processing engine 112 may operate logic circuits in its processor to process such task. When the processing engine 112 receives data (e.g., a location of a service requester/provider) from the user terminal (e.g., the requester terminal 130, or the provider terminals 140), a processor of the processing engine 112 may receive electrical signals encoding/including the data. The processor of the processing engine 112 may receive the electrical signals through an input port. If the user terminal (e.g., the requester terminal 130, or the provider terminals 140) communicates with the processing engine 112 via a wired network, the input port may be physically connected to a cable. If the user terminal (e.g., the requester terminal 130, or the provider terminals 140) communicates with the processing engine 112 via a wireless network, the input port of the processing engine 112 may be one or more antennas, which may convert the electrical signals to electromagnetic signals. Within an electronic device, such as the user terminal (e.g., the requester terminal 130, or the provider terminals 140), and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

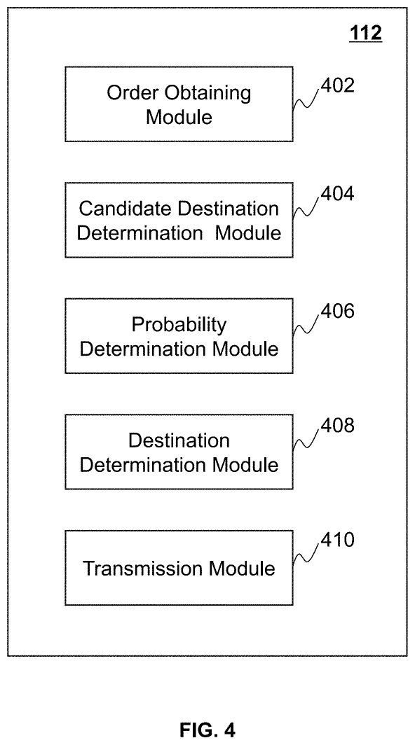

FIG. 4 is a schematic block diagram illustrating an exemplary processing engine 112 according to some embodiments of the present disclosure. The processing engine 112 may include an order obtaining module 402, a candidate destination determination module 404, a probability determination module 406, a destination determination module 408, and a transmission module 410.

The order obtaining module 402 may be configured to determine that a service requester intends to request a transportation service from a first location at a first time point.

In some embodiments, the requester terminal 130 and/or the provider terminal 140 may establish a communication (e.g., wireless communication) with the server 110, through an application (e.g., the application 380 in FIG. 3) installed in the requester terminal 130 and/or the provider terminal 140 via the network 120. The application may associate with the online to offline service system 100. For example, the application may be a taxi-hailing application associated with the online to offline service system 100.

In some embodiments, when the service request opens the application in the requester terminal 130, the application may direct the requester terminal 130 to send, to the processing engine 112, a notice indicating that the application is opened. The processing engine 112 may determine that the service requester intends to request a transportation service based on the notice. Alternatively or additionally, the application installed in the requester terminal 130 may direct the requester terminal 130 to monitor, continuously or periodically, input from the service requester and transmit the input to the processing engine 112 via the network 120. Consequently, the requester terminal 130 may transmit the service requester's input to the processing engine 112 in real-time or substantially real-time. As a result, when the service requester inputs a departure time, a departure location, and/or a destination, the processing engine 112 may determine that the service requester intends to request a transportation service based on the received information. In some embodiments, the processing engine 112 may determine that the service requester intends to request a transportation service based on partial inputs from the service requester. For example, when the service requester starts to input a departure location, and before completing the entire departure location, the processing engine 112 may have already received information related to the partial inputs of the departure location, and determined that the service requester intends to request a transportation service. In some embodiment, the user interactions between the service requester and the requester terminal 130 may be transmitted to the processing engine 112 to determine whether the service requester intends to request a transportation service. The user interactions may include a zoom-in or a zoom-out operation on the map, a drag-and-pull operation on the map, a voice input to activate a mobile application, an opening of an event location from the calendar, an opening of a business unit location in a map such as a restaurant, a UPS store, a movie theatre etc.

The first location may be a departure location of the service requester related to the transportation service. In some embodiments, the departure location may be a specified location input by the service requester through the requester terminal 130 (e.g., the I/O 350 in FIG. 3). In some embodiments, the requester terminal 130 may automatically obtain the departure location. For example, an event such as “Heading for Location A from location B at 10:00 a.m. on Wednesday” is recorded in a calendar in the requester terminal 130. The requester terminal 130 may automatically determine location B as the departure location based on the event in the calendar. In some embodiments, the requester terminal 130 may obtain its location (which is referred to as the location of the service requester) herein through a positioning technology in the requester terminal 130, for example, the GPS, GLONASS, COMPASS, QZSS, BDS, WiFi positioning technology, or the like, or any combination thereof.

The first time point may refer to a departure time related to the transportation service. In some embodiments, the transportation service may be a real-time transportation service that the service requester wishes to receive at the present moment or at a defined time (e.g., 1 minute, 5 minutes, or 10 minutes) reasonably close to the present moment for an ordinary person in the art, so that a service provider is required to depart immediately or substantially immediately after the online to offline service system 100 receives a service request. In this case, the first time point may be the present time (e.g., a time point when the processing engine 112 determines that the service requester intends to request a transportation service).

In some embodiments, a reserved transportation service may refer to a service that the service requester wishes to receive at a time reasonably long from the present moment for the ordinary person in the art, so that a service provider is not required to depart immediately or substantially immediately after the online to offline service system 100 receives a service request. For example, a passenger may need to reserve a taxi service if the time difference between the present time and the service time is longer than a threshold value, such as 20 minutes, 2 hours, or 1 day. In this case, the first time point may be the reserved departure time of the service requester.

In some embodiments, the reserved departure time may be a specified time point input by the service requester through the requester terminal 130 (e.g., the I/O 350 in FIG. 3). In some embodiments, the requester terminal 130 may automatically obtain the appointment departure time. For example, an event such as “Heading for Location A from location B at 10:00 a.m. on Wednesday” is recorded in a calendar in the requester terminal 130. The requester terminal 130 may automatically determine 10:00 a.m. on Wednesday as the appointment departure time based on the event in the calendar.

Alternatively or additionally, the order obtaining module 402 may be configured to obtain a plurality of historical orders requested by the service requester in a first time period prior to the first time point in response to the determination that the service requester intends to request a transportation service. For example, if the first time point is 10:00 a.m. on December 22, the order obtaining module 402 may obtain a plurality of historical orders requested by the service requester in 30 days before December 22. A historical order may be an order that has been completed and/or canceled by the service requester or a service provider. Each of the plurality of historical orders may include a departure location, a destination, and a departure time.

In some embodiments, the departure location of a historical order may be a departure location sent out by the service requester when the service requester requests the historical order or a location where a service provider that accepts the historical order picks up the service requester. The destination of a historical order may be a destination sent out by the service requester when the service requester requests the historical order or a location where the service requester gets off a vehicle of a service provider that accepts the historical order. The departure time of a real-time historical order may be a request time of the real-time historical order or a time point when a service provider that accepts the real-time historical order picks up the service requester. The departure time of a reserved historical order may be an appointment departure time sent out by the service requester when the service requester requests the reserved historical order or a time point when a service provider that accepts the real-time historical order picks up the service requester.

The candidate destination determination module 404 may be configured to determine one or more candidate destinations based on the plurality of historical orders. In some embodiments, the candidate destination determination module 404 may determine the one or more candidate destinations based on the destinations of the plurality of historical orders. For example, if the order obtaining module 402 obtains 5 historical orders, and the destinations of the 5 historical orders are location 1, location 1, location 2, location 3, and location 3, respectively. The candidate destination determination module 404 may determine location 1, location 2, and location 3 as the candidate destinations.

The probability determination module 406 may be configured to select, from the plurality of historical orders, at least one historical order associated with the each of the one or more candidates destinations for each of the one or more candidate destinations based on the first time point.

In some embodiments, the destination of the selected at least one historical order may match the each of the one or more candidate destinations. For example, the one or more candidate destinations may include location 1, location 2, and location 3. For location 1, the probability determination module 406 may select historical orders of which the destinations are location 1 from the plurality of historical orders. In some embodiments, the departure time of the selected at least one historical order may be within a second time period that includes the first time point. For example, if the first time point is 10:00 a.m. on December 22, the departure time of the selected at least one historical order may be within a time period from 9:00 a.m. to 11:00 a.m. in at least one day of the first time period (e.g., the past 30 days).

Alternatively or additionally, the departure location of the selected at least one historical order may be within a distance range including the first location. For example, the departure location of the selected at least one historical order may be within a circular area of which the center point is the first location and the radius may be a certain distance (e.g., 1000 meters).

Alternatively or additionally, the probability determination module 406 may be configured to determine, for the each of the one or more candidate destinations, a probability associated with the each of the one or more candidate destinations based on a first number of the selected at least one historical order and a second number of historical orders associated with the each of the one or more candidate destinations. The probability indicates a likelihood that the service requester intends to travel to the each of the one or more candidate destinations at the first time point.

For example, for a candidate destination, the probability determination module 406 may select at least one historical order from the plurality of historical orders based on the description of 508. The probability determination module 406 may determine the first number of the selected at least one historical order and the second number of historical orders of which the destinations match the candidate destination regardless of the departure times of the historical orders. The probability determination module 406 may determine the probability associated with the candidate destination by dividing the first number by the second number. Merely by way of example, the first time point is 10:00 a.m. on December 22. The order obtaining module 402 obtains 30 historical orders of which the destinations include location 1, location 2, and location 3. For location 1, there are 19 historical orders of which the destinations are location 1 in the 30 historical orders. There are 13 historical orders of which the departure times are within a time period from 9:00 a.m. to 11:00 a.m. in the 19 historical orders. The probability that the service requester intends to travel to location 1 at 10:00 a.m. are 13/19.

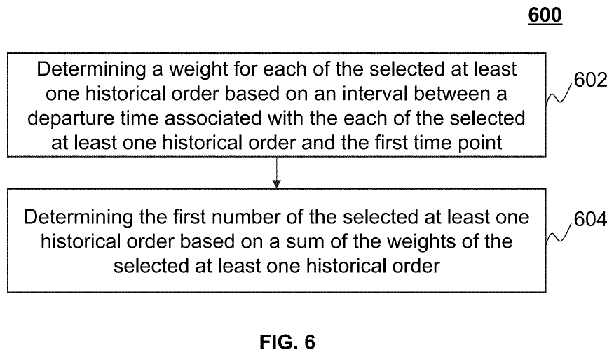

In some embodiments, the longer the interval between the departure time of a historical order and the first time point, the less reliable and less accurate it is to use the historical order to determine the probability. As a result, the probability determination module 406 may determine the probability based on the interval between the departure time of a historical order and the first time point (e.g., as descried elsewhere in this disclosure in detail in connection with FIG. 6).

The destination module 408 may be configured to determine a destination from the one or more candidate destinations based on the one or more probabilities associated with the one or more candidate destinations, respectively. In some embodiments, the destination determination module 408 may select a candidate destination with a maximum probability among the one or more probabilities associated with the one or more candidate destinations. The destination determination module 408 may determine whether the maximum probability exceeds a probability threshold (e.g., 50%, 60%, 70%), wherein the probability threshold may be default in the online to offline service system 100 or a value preset by the user of the online to offline service system 100. In response to a determination that the maximum probability exceeds the probability threshold, the destination determination module 408 may determine the candidate destination with the maximum probability as the destination to be recommended to the service requester.

In some embodiments, if the number of candidate destinations with the maximum probability that exceeds the probability threshold is more than one, all of the more than one candidate destination may be recommended to the service requester. Alternatively, the destination determination module 408 may determine, from the more than one candidate destination, a candidate destination of which the departure time associated therewith is closest to the first time point as the destination to be recommended to the service requester.

The Transmission module 410 may be configured to transmit the destination to be recommended to the service requester to a requester terminal (e.g., the requester terminal 130) associated with the service requester causing the destination displayed on a user interface (e.g., the display 320) of the requester terminal.

The modules in the processing engine 112 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the order obtaining module 402 and the transmission module 410 may be combined into a single module which may both obtain a plurality of historical orders and transmit a destination to be recommended to a service requester. As another example, the order obtaining module 402 may be divided into two units. One unit may be configured to determine that a service requester intends to request a transportation service. The other unit may be configured to obtain a plurality of historical orders.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the processing engine 112 may further include a storage module (not shown in FIG. 4). The storage module may be configured to store data generated during any process performed by any component of in the processing engine 112. As another example, each of components of the processing engine 112 may correspond to a storage module, respectively. Additionally or alternatively, the components of the processing engine 112 may share a common storage module.

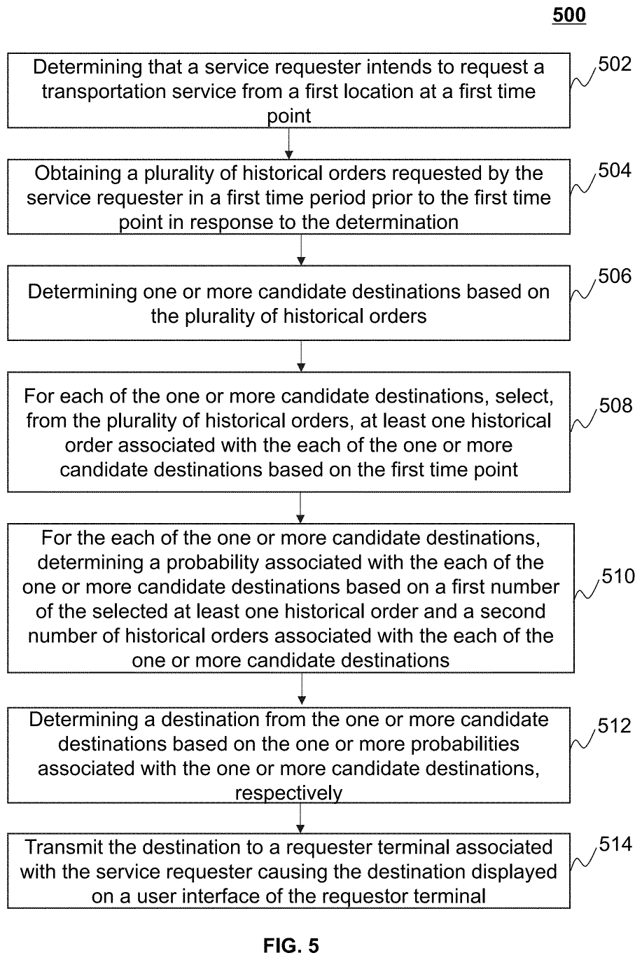

FIG. 5 is a flowchart illustrating an exemplary process for determining a destination for a service requester who intends to request a transportation service according to some embodiments of the present disclosure. In some embodiments, the process 500 may be implemented in the online to offline service system 100 illustrated in FIG. 1. For example, the process 500 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 502, the order obtaining module 402 (or the processing engine 112, and/or the interface circuits 210-a) may determine that a service requester intends to request a transportation service from a first location at a first time point.

In some embodiments, the requester terminal 130 and/or the provider terminal 140 may establish a communication (e.g., wireless communication) with the server 110, through an application (e.g., the application 380 in FIG. 3) installed in the requester terminal 130 and/or the provider terminal 140 via the network 120. The application may associate with the online to offline service system 100. For example, the application may be a taxi-hailing application associated with the online to offline service system 100.

In some embodiments, when the service request opens the application in the requester terminal 130, the application may direct the requester terminal 130 to send, to the processing engine 112, a notice indicating that the application is opened. The processing engine 112 may determine that the service requester intends to request a transportation service based on the notice. Alternatively or additionally, the application installed in the requester terminal 130 may direct the requester terminal 130 to monitor, continuously or periodically, input from the service requester and transmit the input to the processing engine 112 via the network 120. Consequently, the requester terminal 130 may transmit the service requester's input to the processing engine 112 in real-time or substantially real-time. As a result, when the service requester inputs a departure time, a departure location, and/or a destination, the processing engine 112 may determine that the service requester intends to request a transportation service based on the received information. In some embodiments, the processing engine 112 may determine that the service requester intends to request a transportation service based on partial inputs from the service requester. For example, when the service requester starts to input a departure location, and before completing the entire departure location, the processing engine 112 may have already received information related to the partial inputs of the departure location, and determined that the service requester intends to request a transportation service. In some embodiment, the user interactions between the service requester and the requester terminal 130 may be transmitted to the processing engine 112 to determine whether the service requester intends to request a transportation service. The user interactions may include a zoom-in or a zoom-out operation on the map, a drag-and-pull operation on the map, a voice input to activate a mobile application, an opening of an event location from the calendar, an opening of a business unit location in a map such as a restaurant, a UPS store, a movie theatre etc.

The first location may be a departure location of the service requester related to the transportation service. In some embodiments, the departure location may be a specified location input by the service requester through the requester terminal 130 (e.g., the I/O 350 in FIG. 3). In some embodiments, the requester terminal 130 may automatically obtain the departure location. For example, an event such as “Heading for Location A from location B at 10:00 a.m. on Wednesday” is recorded in a calendar in the requester terminal 130. The requester terminal 130 may automatically determine location B as the departure location based on the event in the calendar. In some embodiments, the requester terminal 130 may obtain its location (which is referred to as the location of the service requester) herein through a positioning technology in the requester terminal 130, for example, the GPS, GLONASS, COMPASS, QZSS, BDS, WiFi positioning technology, or the like, or any combination thereof.

The first time point may refer to a departure time related to the transportation service. In some embodiments, the transportation service may be a real-time transportation service that the service requester wishes to receive at the present moment or at a defined time (e.g., 1 minute, 5 minutes, or 10 minutes) reasonably close to the present moment for an ordinary person in the art, so that a service provider is required to depart immediately or substantially immediately after the online to offline service system 100 receives a service request. In this case, the first time point may be the present time (e.g., a time point when the processing engine 112 determines that the service requester intends to request a transportation service).

In some embodiments, a reserved transportation service may refer to a service that the service requester wishes to receive at a time reasonably long from the present moment for the ordinary person in the art, so that a service provider is not required to depart immediately or substantially immediately after the online to offline service system 100 receives a service request. For example, a passenger may need to reserve a taxi service if the time difference between the present time and the service time is longer than a threshold value, such as 20 minutes, 2 hours, or 1 day. In this case, the first time point may be the reserved departure time of the service requester.

In some embodiments, the reserved departure time may be a specified time point input by the service requester through the requester terminal 130 (e.g., the I/O 350 in FIG. 3). In some embodiments, the requester terminal 130 may automatically obtain the appointment departure time. For example, an event such as “Heading for Location A from location B at 10:00 a.m. on Wednesday” is recorded in a calendar in the requester terminal 130. The requester terminal 130 may automatically determine 10:00 a.m. on Wednesday as the appointment departure time based on the event in the calendar.

In 504, the order obtaining module 402 (or the processing engine 112, and/or the interface circuits 210-a) may obtain a plurality of historical orders requested by the service requester in a first time period prior to the first time point in response to the determination that the service requester intends to request a transportation service. For example, if the first time point is 10:00 a.m. on December 22, the order obtaining module 402 may obtain a plurality of historical orders requested by the service requester in 30 days before December 22. A historical order may be an order that has been completed and/or canceled by the service requester or a service provider. Each of the plurality of historical orders may include a departure location, a destination, and a departure time.

In some embodiments, the departure location of a historical order may be a departure location sent out by the service requester when the service requester requests the historical order or a location where a service provider that accepts the historical order picks up the service requester. The destination of a historical order may be a destination sent out by the service requester when the service requester requests the historical order or a location where the service requester gets off a vehicle of a service provider that accepts the historical order. The departure time of a real-time historical order may be a request time of the real-time historical order or a time point when a service provider that accepts the real-time historical order picks up the service requester. The departure time of a reserved historical order may be an appointment departure time sent out by the service requester when the service requester requests the reserved historical order or a time point when a service provider that accepts the real-time historical order picks up the service requester.

In 506, the candidate destination determination module 404 (or the processing engine 112, and/or the processing circuits 210-b) may determine one or more candidate destinations based on the plurality of historical orders. In some embodiments, the candidate destination determination module 404 may determine the one or more candidate destinations based on the destinations of the plurality of historical orders. For example, if the order obtaining module 402 obtains 5 historical orders, and the destinations of the 5 historical orders are location 1, location 1, location 2, location 3, and location 3, respectively. The candidate destination determination module 404 may determine location 1, location 2, and location 3 as the candidate destinations.

In 508, for each of the one or more candidate destinations, the probability determination module 406 (or the processing engine 112, and/or the processing circuits 210-b) may select, from the plurality of historical orders, at least one historical order associated with the each of the one or more candidates destinations based on the first time point.

In some embodiments, the destination of the selected at least one historical order may match the each of the one or more candidate destinations. For example, the one or more candidate destinations may include location 1, location 2, and location 3. For location 1, the probability determination module 406 may select historical orders of which the destinations are location 1 from the plurality of historical orders. In some embodiments, the departure time of the selected at least one historical order may be within a second time period that includes the first time point. For example, if the first time point is 10:00 a.m. on December 22, the departure time of the selected at least one historical order may be within a time period from 9:00 a.m. to 11:00 a.m. in at least one day of the first time period (e.g., the past 30 days).

Alternatively or additionally, the departure location of the selected at least one historical order may be within a distance range including the first location. For example, the departure location of the selected at least one historical order may be within a circular area of which the center point is the first location and the radius may be a certain distance (e.g., 1000 meters).

In 510, for the each of the one or more candidate destinations, the probability determination module 406 (or the processing engine 112, and/or the processing circuits 210-b) may determine a probability associated with the each of the one or more candidate destinations based on a first number of the selected at least one historical order and a second number of historical orders associated with the each of the one or more candidate destinations. The probability indicates a likelihood that the service requester intends to travel to the each of the one or more candidate destinations at the first time point.

For example, for a candidate destination, the probability determination module 406 may select at least one historical order from the plurality of historical orders based on the description of 508. The probability determination module 406 may determine the first number of the selected at least one historical order and the second number of historical orders of which the destinations match the candidate destination regardless of the departure times of the historical orders. The probability determination module 406 may determine the probability associated with the candidate destination by dividing the first number by the second number. Merely by way of example, the first time point is 10:00 a.m. on December 22. The order obtaining module 402 obtains 30 historical orders of which the destinations include location 1, location 2, and location 3. For location 1, there are 19 historical orders of which the destinations are location 1 in the 30 historical orders. There are 13 historical orders of which the departure times are within a time period from 9:00 a.m. to 11:00 a.m. in the 19 historical orders. The probability that the service requester intends to travel to location 1 at 10:00 a.m. are 13/19.

In some embodiments, the longer the interval between the departure time of a historical order and the first time point, the less reliable and less accurate it is to use the historical order to determine the probability. As a result, the probability determination module 406 may determine the probability based on the interval between the departure time of a historical order and the first time point (e.g., as descried elsewhere in this disclosure in detail in connection with FIG. 6).

In 512, the destination determination module 408 (or the processing engine 112, and/or the processing circuits 210-b) may determine a destination from the one or more candidate destinations based on the one or more probabilities associated with the one or more candidate destinations, respectively. In some embodiments, the destination determination module 408 may select a candidate destination with a maximum probability among the one or more probabilities associated with the one or more candidate destinations. The destination determination module 408 may determine whether the maximum probability exceeds a probability threshold (e.g., 50%, 60%, 70%), wherein the probability threshold may be default in the online to offline service system 100 or a value preset by the user of the online to offline service system 100. In response to a determination that the maximum probability exceeds the probability threshold, the destination determination module 408 may determine the candidate destination with the maximum probability as the destination to be recommended to the service requester.

In some embodiments, if the number of candidate destinations with the maximum probability that exceeds the probability threshold is more than one, all of the more than one candidate destination may be recommended to the service requester. Alternatively, the destination determination module 408 may determine, from the more than one candidate destination, a candidate destination of which the departure time associated therewith is closest to the first time point as the destination to be recommended to the service requester.

In 514, the transmission module 410 may transmit the destination to be recommended to the service requester to a requester terminal (e.g., the requester terminal 130) associated with the service requester causing the destination displayed on a user interface (e.g., the display 320) of the requester terminal.

FIG. 6 is a schematic diagram illustrating an exemplary process for determining a first number of selected at least one historical order according to some embodiments of the present disclosure. In some embodiments, the process 600 may be implemented in the online to offline service system 100 illustrated in FIG. 1. For example, the process 600 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting. In some embodiments, part of step 510 (e.g., determination of the first number of the selected at least one historical order) of the process 500 illustrated in FIG. 5 may be performed according to the process 600.

In 602, the probability determination module 408 (or the processing engine 112, and/or the processing circuits 210-b) may determine a weight for each of the selected at least one historical order based on an interval between a departure time associated with each of the selected at least one historical order and the first time point. In some embodiments, the weight for each of the selected at least one historical order may be different based on the interval between the departure time associated with each of the selected at least one historical order and the first time point. For example, the longer the interval between the departure time associated with a selected historical order and the first time point is, the smaller the weight corresponding to the selected historical order may be.

In some embodiments, in order to determine the weight for each of the selected at least one historical order, a half-life may be determined based on the plurality of historical orders. The half-life may be related to a departure time associated with at least one of the plurality of historical orders, a departure location associated with at least one of the plurality of historical orders, a destination associated with at least one of the plurality of historical orders, a distance (e.g., a straight-line distance, a travel distance) between a departure location and a destination associated with at least one of the plurality of historical orders, the number of the plurality of historical orders, or the like, or any combination thereof. According to the half-life and the interval between the departure time associated with each of the selected at least one historical order and the first time point, the probability determination module 408 may determine the weight for each of the selected at least one historical order.

For example, the probability determination module 408 may determine the weight for a selected historical order based on Equation (1) below:

wᵢ=(½)^{Δt/τ}, (1)

where, wᵢ refers to the weight associated with a selected historical order, Δt refers to the interval between a departure time associated with the selected historical order and the first time point, and τ refers to the half-life.

In 604, the probability determination module 408 (or the processing engine 112, and/or the processing circuits 210-b) may determine the first number of the selected at least one historical order based on a sum of the weights of the selected at least one historical order.

For example, the probability determination module 408 may determine the first number of the selected at least one historical order according to Equation (2):

N=Σᵢ₌₁^{M}wᵢ, (2)

where, N refers to the first number of the selected at least one historical order.

Merely by way of example, the selected at least one historical order includes order 1, order 2, and order3. The weights associated with order 1, order 2, and order 3 are 0.5, 0.6, and 0.8, respectively. Without considering the weights associated with order 1, order 2, and order 3, the first number of the selected at least one historical order may be 3. When the weights associated with order 1, order 2, and order 3 are considered, the first number of the selected at least one historical order may be 1.9 (0.5+0.6+0.8=1.9).

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for predicting a destination in an online to offline service system, the system comprising:
one or more storage devices storing a set of instructions; and
one or more processors configured to communicate with the one or more storage devices, wherein when executing the set of instructions, the one or more processors are configured to cause the system to:
determine that a service requester intends to request a service from a first location at a first time point;
obtain a plurality of historical orders requested by the service requester in a first time period prior to the first time point in response to the determination;
determine one or more candidate destinations based on the plurality of historical orders;
for each of the one or more candidate destinations,
select, from the plurality of historical orders, at least one historical order associated with the each of the one or more candidate destinations based on the first time point; and
determine a probability associated with the each of the one or more candidate destinations based on a number of the selected at least one historical order and a number of historical orders associated with the each of the one or more candidate destinations, wherein the probability indicates a likelihood that the service requester intends to travel to the each of the one or more candidate destinations at the first time point; and
determine, from the one or more candidate destinations, a destination to be recommended to the service requester based on the one or more probabilities associated with the one or more candidate destinations, respectively.

2. The system of claim 1, the one or more processors are further configured to cause the system to:
transmit the destination to a requester terminal associated with the service requester causing the destination displayed on a user interface of the requestor terminal.

3. The system of claim 1, wherein a destination of the selected at least one historical order matches the each of the one or more candidate destinations, and a departure time associated with the selected at least one historical order is within a second time period that includes the first time point.

4. The system of claim 1, wherein a departure location associated with the selected at least one historical order is within a distance range including the first location.

5. The system of claim 1, wherein the number of the selected at least one historical order is determined by:
determining a weight for each of the selected at least one historical order based on an interval between a departure time associated with the each of the selected at least one historical order and the first time point; and
determining the number of the selected at least one historical order based on a sum of the weights associated with the selected at least one historical order, respectively.

6. The system of claim 5, wherein to determine the weight for each of the selected at least one historical order, the one or more processors are configured to cause the system to:
determine a half-life based on the plurality of historical orders; and
determine the weight for the each of the selected at least one historical order based on the half-life and the interval between the departure time associated with each of the selected at least one historical order and the first time point.

7. The system of claim 1, wherein to determine, from the one or more candidate destinations, the destination to be recommended to the service requester based on the one or more probabilities associated with the one or more candidate destinations, respectively, the one or more processors are configured to cause the system to:
select a candidate destination with a maximum probability from the one or more candidate destinations;
determine whether the maximum probability exceeds a probability threshold; and
determine the candidate destination with the maximum probability as the destination to be recommended to the service requester in response to a determination that the maximum probability exceeds a probability threshold.

8. A method for predicting a destination in an online to offline service system implemented on a computing device having one or more storage devices and one or more processors, the method comprising:
determining that a service requester intends to request a service from a first location at a first time point;
obtaining a plurality of historical orders requested by the service requester in a first time period prior to the first time point in response to the determination;
determining one or more candidate destinations based on the plurality of historical orders;
for each of the one or more candidate destinations,
selecting, from the plurality of historical orders, at least one historical order associated with the each of the one or more candidate destinations based on the first time point; and
determining a probability associated with the each of the one or more candidate destinations based on a number of the selected at least one historical order and a number of historical orders associated with the each of the one or more candidate destinations, wherein the probability indicates a likelihood that the service requester intends to travel to the each of the one or more candidate destinations at the first time point; and
determining, from the one or more candidate destinations, a destination to be recommended to the service requester based on the one or more probabilities associated with the one or more candidate destinations, respectively.

9. The method of claim 8, the method further comprising:
transmitting the destination to a requester terminal associated with the service requester causing the destination displayed on a user interface of the requestor terminal.

10. The method of claim 8, wherein a destination of the selected at least one historical order matches the each of the one or more candidate destinations, and a departure time associated with the selected at least one historical order is within a second time period that includes the first time point.

11. The method of claim 8, wherein a departure location associated with the selected at least one historical order is within a distance range including the first location.

12. The method of claim 8, wherein the number of the selected at least one historical order is determined by:
determining a weight for each of the selected at least one historical order based on an interval between a departure time associated with the each of the selected at least one historical order and the first time point; and
determining the number of the selected at least one historical order based on a sum of the weights associated with the selected at least one historical order, respectively.

13. The method of claim 12, wherein the determining of the weight for each of the selected at least one historical order includes:
determining a half-life based on the plurality of historical orders; and
determining the weight for the each of the selected at least one historical order based on the half-life and the interval between the departure time associated with each of the selected at least one historical order and the first time point.

14. The method of claim 8, wherein the determining of the destination to be recommended to the service requester based on the one or more probabilities associated with the one or more candidate destinations from the one or more candidate destinations includes:
selecting a candidate destination with a maximum probability from the one or more candidate destinations;
determining whether the maximum probability exceeds a probability threshold; and
determining the candidate destination with the maximum probability as the destination to be recommended to the service requester in response to a determination that the maximum probability exceeds a probability threshold.

15-21. (canceled)

22. A non-transitory computer readable medium, comprising at least one set of instructions for predicting a destination in an online to offline service system, wherein when executed by one or more processors of a computing device, the at least one set of instructions causes the computing device to perform a method, the method comprising:
determining that a service requester intends to request a service from a first location at a first time point;
obtaining a plurality of historical orders requested by the service requester in a first time period prior to the first time point in response to the determination;
determining one or more candidate destinations based on the plurality of historical orders;
for each of the one or more candidate destinations,
selecting, from the plurality of historical orders, at least one historical order associated with the each of the one or more candidate destinations based on the first time point; and
determining a probability associated with the each of the one or more candidate destinations based on a number of the selected at least one historical order and a number of historical orders associated with the each of the one or more candidate destinations, wherein the probability indicates a likelihood that the service requester intends to travel to the each of the one or more candidate destinations at the first time point; and
determining, from the one or more candidate destinations, a destination to be recommended to the service requester based on the one or more probabilities associated with the one or more candidate destinations, respectively.

23. The non-transitory computer readable medium of claim 22, the method further comprising:
transmitting the destination to a requester terminal associated with the service requester causing the destination displayed on a user interface of the requestor terminal.

24. The non-transitory computer readable medium of claim 22, wherein a destination of the selected at least one historical order matches the each of the one or more candidate destinations, and a departure time associated with the selected at least one historical order is within a second time period that includes the first time point.

25. (canceled)

26. The non-transitory computer readable medium of claim 22, wherein the number of the selected at least one historical order is determined by:
determining a weight for each of the selected at least one historical order based on an interval between a departure time associated with the each of the selected at least one historical order and the first time point; and
determining the number of the selected at least one historical order based on a sum of the weights associated with the selected at least one historical order, respectively.

27. The non-transitory computer readable medium of claim 26, wherein the determining of the weight for each of the selected at least one historical order includes:
determining a half-life based on the plurality of historical orders; and
determining the weight for the each of the selected at least one historical order based on the half-life and the interval between the departure time associated with each of the selected at least one historical order and the first time point.

28. The non-transitory computer readable medium of claim 22, wherein the determining of the destination to be recommended to the service requester based on the one or more probabilities associated with the one or more candidate destinations from the one or more candidate destinations includes:
selecting a candidate destination with a maximum probability from the one or more candidate destinations;
determining whether the maximum probability exceeds a probability threshold; and
determining the candidate destination with the maximum probability as the destination to be recommended to the service requester in response to a determination that the maximum probability exceeds a probability threshold.
